(19) United States
(12) Patent Application Publication
(10) Pub. No.: US 2022/0036093 A1
(43) Pub. Date: Feb. 3, 2022

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Takumi Kimura, Tokyo (JP)

(21) Appl. No.: 17/374,866

(22) Filed: Jul. 13, 2021

(30) Foreign Application Priority Data
Jul. 31, 2020 (JP) 2020-130510

(51) Int. Cl. G06K 9/00; G06T 7/11; G06T 7/215; G06T 7/292

(52) U.S. Cl. CPC G06K 9/00771; G06T 7/11; G06T 2207/30196; G06T 7/292; G06T 2207/30242; G06T 7/215

(57) ABSTRACT

An information processing apparatus includes an acquisition unit configured to acquire, for each of a plurality of different locations on a passage line set based on a user operation on an image captured by an imaging unit, a number of objects that have passed through the passage line, and a display control unit configured to display, for each of the plurality of different locations on the passage line, information based on the number of objects that have passed through the passage line on a display unit.

### BACKGROUND

### Field

The present disclosure relates to an information processing technique.

### Description of the Related Art

There is a technique for counting the number of objects that have passed a passage line by setting the passage line on an image captured by an imaging apparatus and detecting objects included in the image passing through the passage line.

Japanese Patent Application Laid-Open No. 2017-118324 discusses a method for counting the number of people who have passed through a passage line on a captured image per passage direction of the passage line and displaying a count result per passage direction on a display.

There are cases where a user wishes to grasp the bias in the number of objects that have passed through a passage line on an image, to grasp a more detailed passage status of the objects that have passed through the passage line. A possible method for achieving this purpose is allowing a user to set a plurality of passage lines on an image and displaying a count result indicating the number of objects that have passed through each of the passage lines. In this way, the bias in the number of objects that have passed through each of the passage lines is presented to the user. However, in this case, the user needs to set the plurality of passage lines, which is a complex operation for the user.

### SUMMARY

According to an aspect of some embodiments, an information processing apparatus includes an acquisition unit configured to acquire, for each of a plurality of different locations on a passage line set based on a user operation on an image captured by an imaging unit, a number of objects that have passed through the passage line, and a display control unit configured to display, for each of the plurality of different locations on the passage line, information based on the number of objects that have passed through the passage line on a display unit.

Further features of various embodiments will become apparent from the following description of exemplary embodiments with reference to the attached drawings.

### BRIEF DESCRIPTION OF THE DRAWINGS

FIG. 1 illustrates an example of a system configuration.

FIG. 2 is a functional block diagram of an information processing apparatus.

FIG. 3 illustrates passage determination processing.

FIG. 4 illustrates passage information.

FIG. 5 illustrates output image generation processing.

FIGS. 6A and 6B illustrate the output image generation processing.

FIG. 7 is a flowchart illustrating the passage determination processing.

FIG. 8 is a flowchart illustrating the output image generation processing.

FIG. 9 illustrates output image generation processing.

FIG. 10 illustrates the output image generation processing.

FIG. 11 illustrates a hardware configuration of each apparatus.

### DESCRIPTION OF THE EMBODIMENTS

Embodiments in the present disclosure enable a user to grasp a more detailed passage status of the objects that have passed through a passage line with a simple operation.

Hereinafter, exemplary embodiments will be described with reference to the accompanying drawings. The configurations described in the following exemplary embodiments are only examples, and some embodiments are not limited to the illustrated configurations.

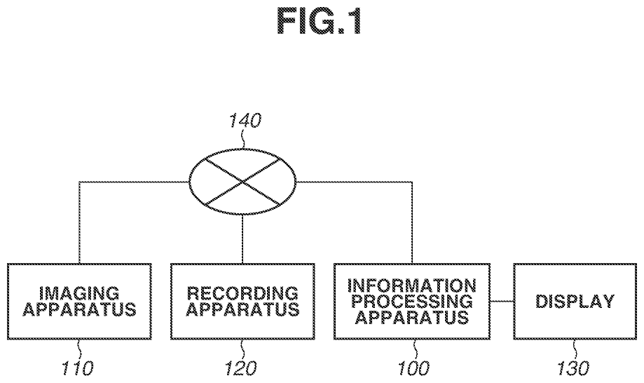

FIG. 1 illustrates a system configuration according to a first exemplary embodiment. The system according to the present exemplary embodiment includes an information processing apparatus 100, an imaging apparatus 110, a recording apparatus 120, and a display 130.

The information processing apparatus 100, the imaging apparatus 110, and the recording apparatus 120 are connected to each other via a network 140. For example, the network 140 is realized by a plurality of routers, switches, cables that comply with communication standards, such as Ethernet®.

The network 140 may be realized by the Internet, a wired local area network (LAN), a wireless LAN, or a wide area network (WAN), for example.

The information processing apparatus 100 is, for example, realized by a personal computer in which a program for realizing the functions of the information processing to be described below is installed. The imaging apparatus 110 is an apparatus that captures images and functions as imaging means. The imaging apparatus 110 associates the image data of a captured image, information about the imaging date and time of the captured image, and identification information, which is the information identifying the imaging apparatus 110, with each other and transmits the associated information to external apparatuses, such as the information processing apparatus 100 and the recording apparatus 120, via the network 140. While the system according to the present exemplary embodiment includes only one imaging apparatus 110, the system may include a plurality of imaging apparatuses 110. That is, a plurality of imaging apparatuses 110 may be connected to the information processing apparatus 100 and the recording apparatus 120 via the network 140. In this case, the information processing apparatus 100 and the recording apparatus 120 determine which one of the plurality of imaging apparatuses 110 has captured a transmitted image, by using the identification information associated with the transmitted image, for example.

The recording apparatus 120 records the image data of an image captured by the imaging apparatus 110, the information about the imaging date and time of the captured image, and the identification information identifying the imaging apparatus 110 in association with each other. In addition, in accordance with a request from the information processing apparatus 100, the recording apparatus 120 transmits the recorded data (the image, the identification information, and the like) to the information processing apparatus 100.

The display 130 is a liquid crystal display (LCD) or the like and displays an output image, which will be described below, generated by the information processing apparatus 100 and an image captured by the imaging apparatus 110, for example. The display 130 is connected to the information processing apparatus 100 via a display cable that complies with communication standards such as high definition multimedia interface (HDMI®). At least two or all of the display 130, the information processing apparatus 100, and the recording apparatus 120 may be incorporated in a single enclosure.

While the output image generated by the information processing apparatus 100 and the image captured by the imaging apparatus 110 are displayed on the display 130 connected to the information processing apparatus 100 via the above display cable in the present exemplary embodiment, the above images may be displayed on a display of any one of the following external apparatuses, for example. That is, the images may be displayed on a display of a mobile device, such as a smartphone or a tablet terminal, connected to the information processing apparatus 100 via the network 140.

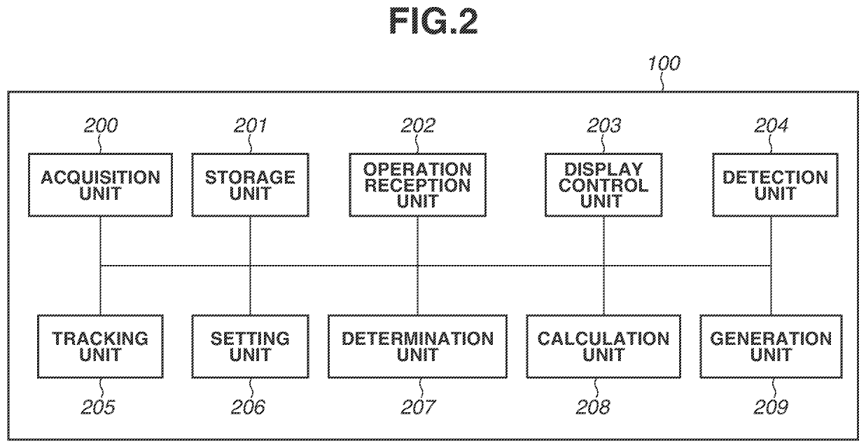

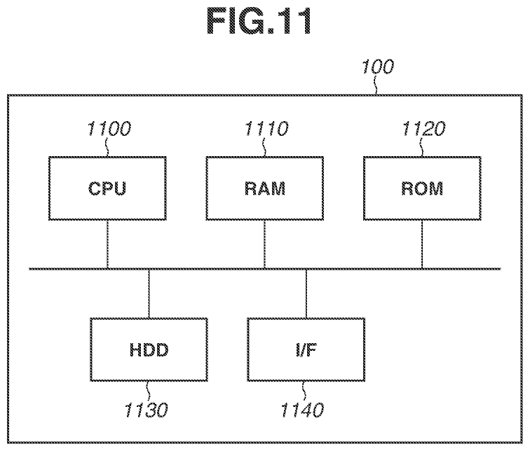

Next, information processing of the information processing apparatus 100 according to the present exemplary embodiment will be described with reference to a functional block diagram of the information processing apparatus 100 according to the present exemplary embodiment in FIG. 2. The present exemplary embodiment will be described assuming that each of the functions illustrated in FIG. 2 is realized as follows by using a read-only memory (ROM) 1120 and a central processing unit (CPU) 1100, which will be described below with reference to FIG. 11. That is, the functions illustrated in FIG. 2 are realized by causing the CPU 1100 of the information processing apparatus 100 to execute a computer program stored in the ROM 1120 of the information processing apparatus 100.

An acquisition unit 200 sequentially acquires the images of the respective frames constituting a moving image captured by the imaging apparatus 110. The acquisition unit 200 may acquire a moving image transmitted from the imaging apparatus 110 or may acquire a moving image transmitted from the recording apparatus 120.

A storage unit 201 may be realized by, for example, a random access memory (RAM) 1110 or a hard disk drive (HDD) 1130, which will be described below with reference to FIG. 11. For example, the storage unit 201 stores (holds) the image data of an image acquired by the acquisition unit 200. In addition, for example, the storage unit 201 stores information about parameters of a passage line, which will be described below. An operation reception unit 202 receives a user operation via an input device (not illustrated), such as a keyboard or a mouse. A display control unit 203 displays, for example, an image captured by the imaging apparatus 110, a setting screen on which settings about the information processing according to the present exemplary embodiment are made, and information indicating a result of the information processing on the display 130.

A detection unit 204 performs processing for detecting an object (a subject) included in the image captured by the acquisition unit 200. The detection unit 204 according to the present exemplary embodiment performs pattern matching processing with a matching pattern (a dictionary), to detect an object in the image. When people in an image are detected as the detection target objects, the detection unit 204 may use a plurality of matching patterns, such as a matching pattern including a person facing the front and a matching pattern including a person facing sideways. The detection accuracy is expected to improve by performing detection processing with a plurality of matching patterns as described above. A matching pattern including a certain object seen from a different angle, such as from a diagonal direction or an upward direction, may also be prepared. In a case where a person is detected as a specific object, a matching pattern (a dictionary) indicating features of the whole body does not necessarily need to be prepared. A matching pattern only for a part of a person, such as the upper body, the lower body, the head, the face, or a leg, may be prepared.

While the detection unit 204 according to the present exemplary embodiment uses pattern matching processing to detect people as the detection target objects, the detection unit 204 may use a different conventional technique to detect people in images. In addition, while the detection unit 204 according to the present exemplary embodiment detects people as the detection target objects, the detection unit 204 may detect other objects such as cars, instead of people. The detection target objects may be moving objects in images. In this case, the detection unit 204 detects moving objects in captured images by using a known technique, such as an inter-frame difference method or a background difference method, for example.

A tracking unit 205 tracks objects detected by the detection unit 204. If the detection unit 204 according to the present exemplary embodiment detects a person in the image of a frame of interest, the person being the same as that detected in any one of the images of the previous frames of the target frame, the tracking unit 205 associates the person in these frames with each other. That is, the tracking unit 205 tracks a person in the images of a plurality of frames temporally close to each other.

The tracking unit 205 determines whether the same object appears in the images of a plurality of frames. For example, if the tracking unit 205 determines that the current location of a detected object and a predicted location of the detected object after its movement fall within a certain distance by using the motion vector of the detected object, the tracking unit 205 determines that these objects are the same object. Alternatively, the tracking unit 205 may associate highly correlated objects in the images of a plurality of frames with each other by using, for example, the colors, shapes, or sizes (number of pixels) of the objects. Thus, as long as the tracking unit 205 is able to determine whether the same object appears in the images of a plurality of frames and track the same object, the tracking unit 205 may use a different tracking and determination method.

The setting unit 206 sets a passage line, which is a line for determining the passage of an object tracked by the tracking unit 205. For example, the operation reception unit 202 may receive information about two user-specified locations in an image displayed by the display control unit 203 on the display 130, and the setting unit 206 may set a line connecting the two points as the passage line. The setting unit 206 may set a line previously registered on the image as the passage line.

A determination unit 207 determines, for each of a plurality of different locations on a single passage line set by the setting unit 206, whether an object tracked by the tracking unit 205 has passed through the single passage line. In this determination, the determination unit 207 determines the location through which the object has passed among the plurality of different locations on the single passage line. The determination unit 207 also determines the passage direction of the object with respect to the passage line. Depending on the determination result of the determination unit 207, the storage unit 201 stores the location through which the object has passed among the plurality of different locations on the single passage line, the passage direction of the object, and the date and time when the object has passed through the single passage line in association with each other.

A calculation unit 208 acquires, for each of the plurality of different locations on the single passage line set by the setting unit 206, the number of objects that have passed through the single passage line. Specifically, for each of the plurality of different locations on the single passage line, the calculation unit 208 counts the number of objects whose passage through the passage line has been determined by the determination unit 207. In addition, for each of the plurality of different locations on the single passage line, the calculation unit 208 according to the present exemplary embodiment counts the number of objects that have passed through the single passage line per passage direction.

A generation unit 209 generates an output image by superimposing information based on the number of objects that have passed through the single passage line set by the setting unit 206 for each of the plurality of different locations on the single passage line on an image captured by the imaging apparatus 110. The display control unit 203 displays the output image generated by the generation unit 209 on the display 130.

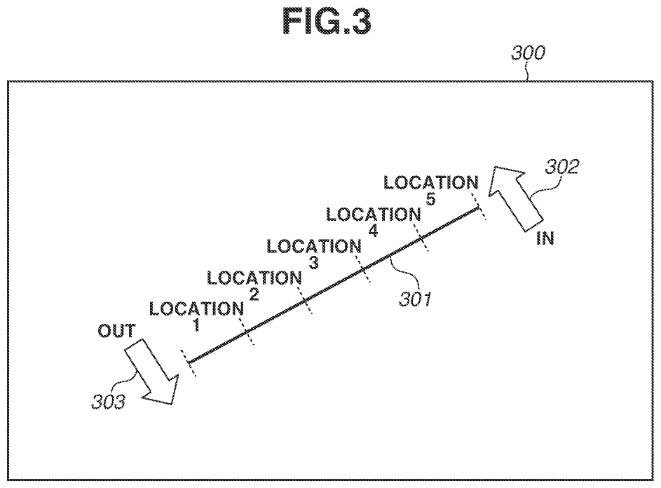

Next, the information processing of the information processing apparatus 100 according to the present exemplary embodiment will be described in more detail with reference to FIGS. 3 to 6. FIG. 3 illustrates a single passage line 301 set by the setting unit 206 on an image 300 captured by the imaging apparatus 110. As illustrated in FIG. 3, the passage line 301 is set on the captured image 300. In addition, the setting unit 206 according to the present exemplary embodiment sets a plurality of different locations on the single passage line 301 set on the image 300 based on a user operation specifying the single passage line 301 on the image 300. In the example illustrated in FIG. 3, by dividing the single passage line 301 into five segments, the setting unit 206 sets five different locations (sections) on the single passage line 301. Identification information identifying each of the plurality of different locations set on the passage line 301 by the setting unit 206 is set, and the storage unit 201 stores the identification information identifying each of the plurality of different locations. In the example illustrated in FIG. 3, identification information “location 1” to “location 5” is given as the identification information identifying each of the plurality of different locations set on the single passage line 301. In addition, FIG. 3 includes a mark 302 indicating a first direction (an IN direction) with respect to the single passage line 301 set by the setting unit 206 and a mark 303 indicating a second direction (an OUT direction) with respect to the single passage line 301. The display control unit 203 may display, on the display 130, the image 300 on which the single passage line, the mark 302 indicating the first direction with respect to the single passage line, the mark 303 indicating the second direction with respect to the single passage line, and the information indicating each of the plurality of different locations are superimposed. That is, the display control unit 203 may display the image 300 illustrated in FIG. 3 on the display 130. In the example illustrated in FIG. 3, while the setting unit 206 sets five different locations (sections) on the single passage line, the number of different locations is not limited to five. The setting unit 206 sets at least two different locations on a single passage line. In addition, the number of the plurality of different locations (sections) set on the single passage line may be a preset number or may be set by a user instruction. That is, the number of different locations (sections) on the single passage line is settable based on a user operation. For example, the operation reception unit 202 may receive a user operation specifying the number of different locations to be set on the single passage line, and the setting unit 206 may set, based on the user operation received by the operation reception unit 202, the number of different locations specified by the user on the single passage line. For example, if the operation reception unit 202 receives a user operation indicating 10 as the number of different locations set on the single passage line, the setting unit 206 divides the single passage line into 10 sections and sets the 10 locations on the single passage line.

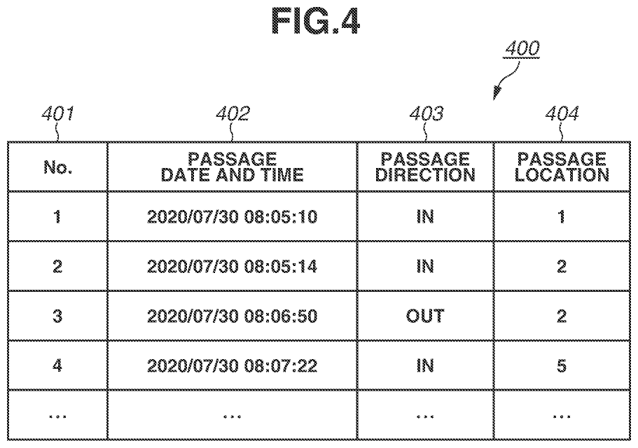

Next, passage information 400 stored in the storage unit 201 will be described with reference to FIG. 4. The passage information 400 illustrated in FIG. 4 is information stored in the storage unit 201, and the following information is held in the passage information 400, for example. That is, the passage information 400 holds event information 401 identifying an event of an object passing through a single passage line, passage date and time 402 when the object has passed through the single passage line, a passage direction 403 with respect to the single passage line, and a passage location 404 identifying a location on the single passage line through which the object has passed in association with each other. In the example illustrated in FIG. 4, event No “1” indicated by the event information 401 indicates that an object has passed through “location 1” among the plurality of different locations on the passage line 301 illustrated in FIG. 3 in the IN direction at “2020/07/30 08:05:10”. As the information held in the passage information 400, information other than the information illustrated in FIG. 4 may also be held. For example, for each of the objects that have passed through the passage line 301, information such as the size of the object or the passage speed of the object may be held, in addition to the information illustrated in FIG. 4.

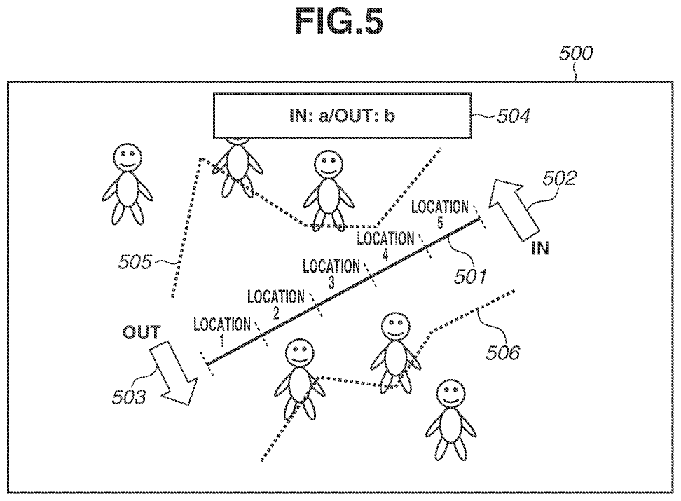

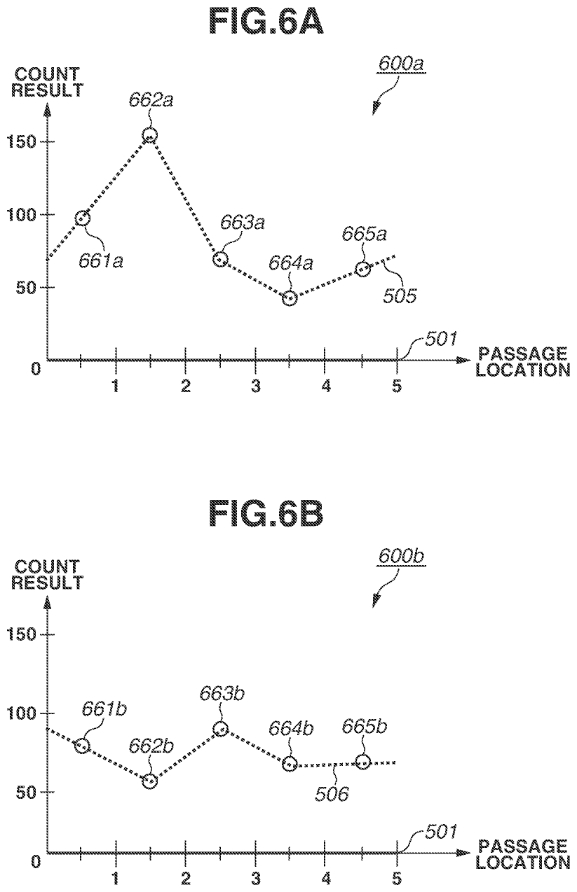

Next, processing for generating an output image displayed by the information processing apparatus 100 according to the present exemplary embodiment on the display 130 will be described with reference to FIGS. 5 and 6. FIG. 5 illustrates an output image generated by the generation unit 209 and displayed by the display control unit 203 on the display 130. The generation unit 209 according to the present exemplary embodiment generates a figure 505 corresponding to a graph based on the number of objects that passes through a single passage line 501 in an IN direction 502 for each of the five location “location 1” to “location 5” on the passage line 501. Likewise, the generation unit 209 generates a figure 506 corresponding to a graph based on the number of objects that passes through the single passage line 501 in an OUT direction 503 for each of the five location “location 1” to “location 5” on the passage line 501. Next, the generation unit 209 generates an output image by superimposing the generated figures 505 and 506 on a captured image 500. The generation unit 209 according to the present exemplary embodiment generates an output image by superimposing the following information on the captured image 500. That is, the generation unit 209 generates an output image by superimposing the figure 505, the figure 506, the mark 502 indicating the IN direction, the mark 503 indicating the OUT direction, the single passage line 501, characters identifying the five different locations, and information 504 indicating the number of people who have passed the single passage line 501 on the image 500. The information 504 indicating the number of people who have passed the single passage line 501 includes a count result obtained by counting the number of objects that have passed through the single passage line 501 in the IN direction 502 during an counting period and a count result obtained by counting the number of objects that have passed through the single passage line 501 in the OUT direction 503 during the counting period.

Next, processing for generating graphs for generating the output image illustrated in FIG. 5 will be described with reference to FIGS. 6A and 6B. These graphs are each based on the number of objects that have passed through the passage line 501 for each of the plurality of different locations. A graph 600a illustrated in FIG. 6A is a graph indicating a count result of the objects that have passed through the passage line 501 in the IN direction 502 illustrated in FIG. 5 for each of the five locations “location 1” to “location 5” in FIG. 5. In addition, a graph 600b illustrated in FIG. 6B is a graph indicating a count result of the objects that have passed through the passage line 501 in the OUT direction 503 illustrated in FIG. 5 for each of the five locations “location 1” to “location 5” in FIG. 5. The horizontal axis of the graph 600a and graph 600b indicates the locations on the passage line set on the image 500. Specifically, 0 or more and less than 1 corresponds to the section of “location 1”, and 1 or more and less than 2 corresponds to the section of “location 2”. In addition, 2 or more and less than 3 corresponds to the section of “location 3”, and 3 or more and less than 4 corresponds to the section of “location 4”. In addition, 4 or more and less than 5 corresponds to the section of “location 5”. In each of the graphs 600a and 600b illustrated in FIGS. 6A and 6B, a line 501 corresponding to the passage line 501 illustrated in FIG. 5 is illustrated for convenience.

First, a method for generating the graph 600a corresponding to a count result of the objects that have passed through the passage line 501 set on the image 500 in the IN direction 502 for each of the different locations will be described. The calculation unit 208 according to the present exemplary embodiment acquires a count result of the objects that have passed through the passage line 501 on the image 500 illustrated in FIG. 5 in the IN direction 502 during an counting period for each of the five different locations (five different sections), which are “location 1” to “location 5”, on the passage line 501. This counting period is a period in which the number of objects that have passed through the passage line 501 is counted. For example, assuming that the counting period is “2020/07/DAY 13:00 to 14:00”, the calculation unit 208 acquires a count result of the objects that have passed through the passage line 501 in the IN direction 502 during the counting period for each of the five different locations “location 1” to “location 5”. Next, the generation unit 209 renders, for each of the locations “location 1” to “location 5”, an element based on the count result of the objects that have passed through the passage line 501 in the IN direction 502 on the graph 600a. The following example assumes that the calculation unit 208 acquires “100” as the count result of the objects that have passed through the section of “location 1” on the passage line 501 illustrated in FIG. 5 in the IN direction 502 during the counting period “2020/07/DAY 13:00 to 14:00”. In other words, the following example assumes that 100 objects have passed through the section “location 1” on the passage line 501 in the IN direction 502 during the counting period “2020/07/DAY 13:00 to 14:00”. In this case, the generation unit 209 determines a section (0 to 1) on the horizontal axis of the graph 600a, the section (0 to 1) corresponding to “location 1” on the passage line 501, and plots an element 661a at the location corresponding to numerical value 100 on the vertical axis (count result) and the midpoint (0.5) of the determined section on the horizontal axis. That is, the element 661a plotted by the generation unit 209 indicates the number (100) of objects that have passed through the section of “location 1” illustrated in FIG. 5 in the IN direction 502 during the counting period. Likewise, the generation unit 209 plots elements 662a to 665a on the graph 600a for “location 2” to “location 5”, respectively. That is, the element 662a plotted on the graph 600a by the generation unit 209 indicates the number of objects that have passed through the section of “location 2” illustrated in FIG. 5 in the IN direction 502 during the counting period. In addition, the element 663a plotted on the graph 600a by the generation unit 209 indicates the number of objects that have passed through the section of “location 3” illustrated in FIG. 5 in the IN direction 502 during the counting period. In addition, the element 664a plotted on the graph 600a by the generation unit 209 indicates the number of objects that have passed through the section of “location 4” illustrated in FIG. 5 in the IN direction 502 during the counting period. In addition, the element 665a plotted on the graph 600a by the generation unit 209 indicates the number of objects that have passed through the section of “location 5” illustrated in FIG. 5 in the IN direction 502 during the counting period.

The generation unit 209 generates the graph 600a by determining a polygonal line 505 connecting the elements 661a to 665a plotted on the graph 600a for the five locations “location 1” to “location 5”. Next, the generation unit 209 generates the output image illustrated in FIG. 5 by superimposing the polygonal line 505 included in the graph 600a as a figure corresponding to the graph 600a based on the count results of the objects that have passed through the plurality of different locations on the passage line 501 on the image 500 in the IN direction 502. According to the present exemplary embodiment, the polygonal line 505 indicating the count results of the objects that have passed through the passage line 501 in the IN direction 502 is superimposed on the image 500 at the following location. That is, first, the image 500 is divided into two areas by extension of the passage line 501. Next, between the two areas of the image 500 obtained by the division, the polygonal line 505 is superimposed on the area where the objects that have passed through the passage line 501 in the IN direction 502 are present. The polygonal line 505 is superimposed on the captured image such that the location relationship between the line (corresponding to the passage line 501) connecting (0, 0) and (5, 0) and the polygonal line 505 in the graph 600a is the same as the location relationship between the passage line 501 and the polygonal line 505 illustrated in FIG. 5. That is, the figure of the polygonal line 505 is superimposed on the captured image such that the relative location of the polygonal line 505 of the graph 600a with respect to the line connecting (0, 0) and (5, 0) of the graph 600a will be the same as the relative location of the polygonal line 505 with respect to the passage line 501 illustrated in FIG. 5.

While the above description has been made on a case in which a figure (the polygonal line 505) corresponding to the graph 600a based on the count results of the objects that have passed through the five locations on the passage line 501 in the IN direction 502 is superimposed on the image 500, like processing is also performed in the OUT direction 503. That is, the calculation unit 208 acquires, for each of the five different locations (five different sections) from “location 1” to “location 5”, a count result of the objects that have passed through the passage line 501 on the image 500 in the OUT direction 503 during the counting period. The generation unit 209 plots, on the graph 600b, elements based on the count results acquired by the calculation unit 208 for the five different locations. As illustrated in FIG. 6B, the generation unit 209 plots elements 661b to 665b for “location 1” to “location 5”, respectively. Next, by determining the polygonal line 506 connecting the plotted elements 661b to 665b, the generation unit 209 generates the graph 600b in the OUT direction 503. Specifically, in the example in FIG. 5, first, the image 500 is divided into two areas by extension of the passage line 501. Next, between the two areas of the image 500 obtained by the division, the polygonal line 506 is superimposed on the area where the objects that have passed through the passage line 501 in the OUT direction 503 are present. As is the case with the IN direction 502, the polygonal line 506 indicating the count results of the objects that have passed through the passage line 501 in the OUT direction 503 is superimposed on the image 500 at the following location. That is, the line (corresponding to the passage line 501) connecting coordinates (0, 0) and coordinates (5, 0) on the graph 600b indicating the count results of the objects that have passed through the passage line 501 in the OUT direction 503 is determined. Next, the polygonal line 506 is superimposed on the image 500 such that the location relationship between the line on the graph 600b and the polygonal line 505 on the graph 600b will be the same as the location relationship between the passage line 501 and the polygonal line 506 illustrated in FIG. 5. As described above, the calculation unit 208 according to the present exemplary embodiment acquires, for each of the plurality of different locations on the passage line 501, a count result of the objects that have passed through the passage line 501 in the IN direction 502 and a count result of the objects that have passed through the passage line 501 in the OUT direction 503. Next, the generation unit 209 generates an output image by superimposing, on the image 500, a figure (the polygonal line 505) corresponding to the graph 600a based on the count results in the IN direction 502 and a figure (the polygonal line 506) corresponding to the graph 600b based on the count results in the OUT direction 503. In the above description, while the polygonal line 505 (the polygonal line 506) is rendered on the graph 600a (the graph 600b) generated in the IN direction 502 (the OUT direction 503), the present exemplary embodiment is not limited to this example. For example, instead of the polygonal line, bars may be rendered or dots may be plotted on the graph 600a (the graph 600b) generated in the IN direction 502 (OUT direction 503). In other words, the figures, each of which is used to generate an output image, superimposed on the image 500, and corresponds to a graph based on the count results for the different locations in the IN direction 502 (or the OUT direction 503) may be represented by bars or dots, instead of polygonal lines.

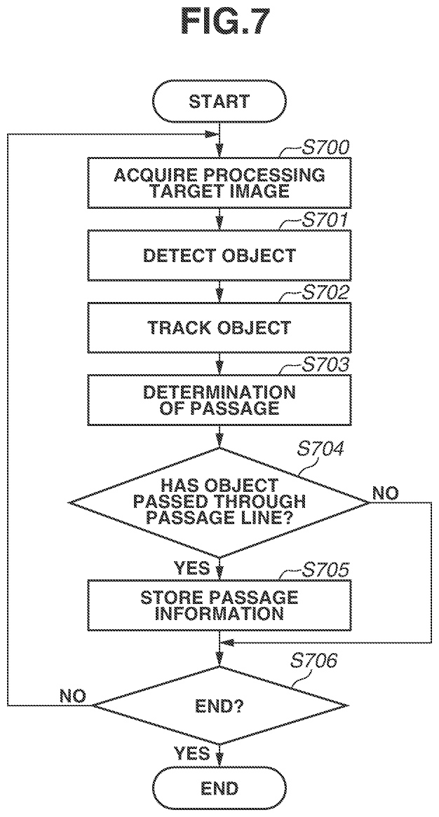

Next, how the information processing apparatus 100 according to the present exemplary embodiment determines whether an object has passed through a passage line will be described with reference to a flowchart illustrated in FIG. 7. In accordance with the flowchart illustrated in FIG. 7, the information processing apparatus 100 according to the present exemplary embodiment is able to perform the following processing. That is, the information processing apparatus 100 is able to track an object in a captured image, determine at least one of the different locations on a passage line set on the image through which this object has passed, and store passage information based on the determination result. The processing illustrated in FIG. 7 is started or ended in accordance with a user instruction, for example. The following description assumes that the processing of the flowchart illustrated in FIG. 7 is executed, for example, by the functional blocks illustrated in FIG. 2 realized by causing the CPU 1100 of the information processing apparatus 100 to execute a computer program stored in the ROM 1120 of the information processing apparatus 100.

First, in S700, the acquisition unit 200 acquires the image of a single frame as the image to be processed (hereinafter, processing target image), from among the images of a plurality of frames constituting a moving image captured by the imaging apparatus 110. Next, in S701, the detection unit 204 detects an object included in the processing target image. If the detection target (and tracking target) is a person, the detection unit 204 detects a person in the processing target image by performing pattern matching processing with a matching pattern for people, for example. Next, in S702, the tracking unit 205 tracks the object detected by the detection unit 204. If the detection unit 204 detects an object from the processing target image, the object having been detected also from the image of a frame before that of the processing target image, the tracking unit 205 associates these objects in the respective frames with each other and tracks the object. In addition, the tracking unit 205 adds a unique ID to each tracking target object. For example, the tracking unit 205 adds an ID “a” to an object detected by the detection unit 204 from the image of a frame before the processing target image. If the detection unit 204 detects this object also in the processing target image, the tracking unit 205 adds the same ID “a” to this object. If a new object is detected on the processing target image, the tracking unit 205 adds another unique ID to this new object.

Next, in S703, the determination unit 207 determines whether the object being tracked by the tracking unit 205 has passed through at least one of the plurality of different locations on a single passage line set by the setting unit 206. In the example illustrated in FIG. 3, the determination unit 207 determines whether the object being tracked by the tracking unit 205 has passed through at least one of the five locations (location 1 to location 5) on the passage line 301. Next, in S704, if the determination unit 207 determines that the object has passed through at least one of the plurality of different locations on the single passage line set by the setting unit 206 (YES in S704), the processing proceeds to S705. In S705, the storage unit 201 records (stores), depending on the determination result, information in the passage information 400. In the example illustrated in FIG. 3, the storage unit 201 associates the passage date and time, which is the date and time of the passage of the object through the passage line 301, the passage direction with respect to the passage line 301, and the location that the object has passed through among the plurality of locations (location 1 to location 5) on the passage line 301 with each other and records (stores) the associated information in the passage information 400.

Next, in S704, if the determination unit 207 determines that the object has not passed through any one of the plurality of different locations on the single passage line set by the setting unit 206 (NO in S704), the processing proceeds to S706. In S706, if there is no user instruction to end the present processing (NO in S706), the processing returns to S700. In S700, the acquisition unit 200 acquires, from among the plurality of frames constituting the moving image captured by the imaging apparatus 110, the image of the next frame of the current processing target image as a new processing target image. In S706, if there is a user instruction to end the present processing (YES in S706), the processing of the flowchart illustrated in FIG. 7 is ended. As described above, by performing the processing of the flowchart illustrated in FIG. 7, the information processing apparatus 100 according to the present exemplary embodiment determines whether an object has passed through at least one of the different locations on the passage line on the image and stores, depending on the determination result, information in the passage information 400.

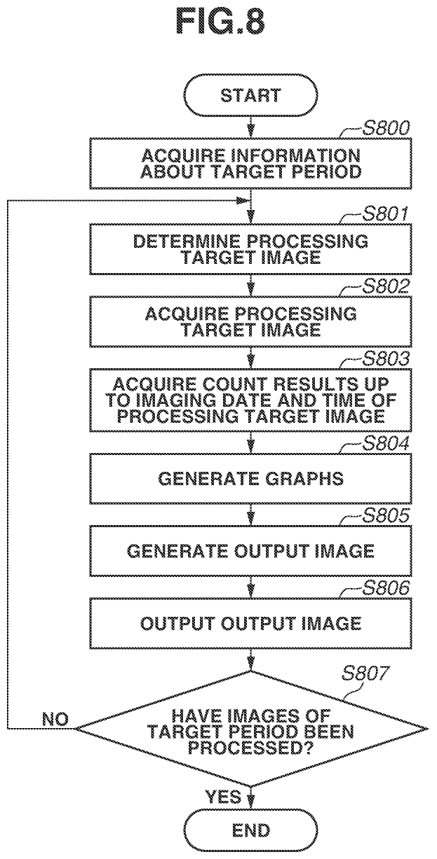

Next, how the information processing apparatus 100 according to the present exemplary embodiment generates an output image will be described with reference to FIG. 8. By executing the processing of the flowchart illustrated in FIG. 8, the information processing apparatus 100 according to the present exemplary embodiment is able to superimpose information based on the count results of the objects that have passed through a passage line on a captured image and generate an output image. The processing illustrated in FIG. 7 is started or ended in accordance with a user instruction, for example. The following description assumes that the processing of the flowchart illustrated in FIG. 7 is executed, for example, by the functional blocks illustrated in FIG. 2 implemented by causing the CPU 1100 of the information processing apparatus 100 to execute a computer program stored in the ROM 1120 of the information processing apparatus 100.

First, in S800, the calculation unit 208 acquires information about a target period indicating a period for which an output image is generated. For example, if the operation reception unit 202 receives a user operation specifying a period “2020/07/DAY 13:00 to 14:00”, the calculation unit 208 acquires information indicating this user-specified period “2020/07/DAY 13:00 to 14:00” as the information about the target period.

Next, in S801, the generation unit 209 determines a single image as the processing target from among the images captured by the imaging apparatus 110 during the target period based on the information acquired in S800. The present exemplary embodiment assumes that, from among the plurality of images captured by the imaging apparatus 110 during the target period, the generation unit 209 preferentially acquires an image having an older imaging time as the processing target image. For example, among the images captured by the imaging apparatus 110 during the target period “2020/07/DAY 13:00 to 14:00”, the generation unit 209 determines the images as the processing target images in a chronological order. Next, in S802, the acquisition unit 200 acquires the image determined as the processing target image in S801. For example, the acquisition unit 200 acquires the image determined by the generation unit 209 as the current processing target from the recording apparatus 120.

Next, in S803, the calculation unit 208 acquires, for each of a plurality of different locations on a passage line, the number of objects that have passed through the passage line during an counting period, which is from the start date and time of the target period to the imaging date and time of the current processing target image based on the passage information 400. The following example assumes that the target period is “2020/07/DAY 13:00 to 14:00” and that the imaging date and time of the current processing target image is “2020/07/DAY 13:30”. In this case, the counting period is “2020/07/DAY 13:00 to 13:30”, which is the period from “2020/07/DAY 13:00”, which is the start date and time of the target period, to “2020/07/DAY 13:30”, which is the imaging date and time of the current processing target image. In S803, the calculation unit 208 refers to the passage information 400 and acquires, for each of the five locations “location 1” to “location 5”, a count result indicating the number of objects that have passed through the passage line 501 in the IN direction 502 during the current counting period. Likewise, the calculation unit 208 refers to the passage information 400 and acquires, for each of the five locations “location 1” to “location 5”, a count result indicating the number of objects that have passed through the passage line 501 in the OUT direction 503 during the current counting period. As described above, in the flowchart illustrated in FIG. 8, the counting period in which the count results are obtained dynamically changes in a user-specified target period, depending on the imaging date and time of the current processing target image.

Next, in S804, based on the count results acquired by the calculation unit 208 in S803, the generation unit 209 generates a graph based on the count results of the objects that have passed through the passage line per passage direction. In the examples illustrated in FIGS. 5 and 6, the generation unit 209 generates the graph 600a based on the count results of the objects that have passed through the five locations on the passage line 501 on the image 500 in the IN direction 502 during the counting period. In addition, the generation unit 209 generates the graph 600b based on the count results of the objects that have passed through the five locations on the passage line 501 in the OUT direction 503 during the counting period.

Next, in S805, the generation unit 209 generates an output image by superimposing the figures corresponding to the graphs generated in S804 on the current processing target image. In the examples illustrated in FIGS. 5 and 6, the generation unit 209 generates an output image by performing the following processing. That is, the generation unit 209 generates an output image by superimposing a figure (the polygonal line 505) corresponding to the graph 600a based on the count results in the IN direction 502 and a figure (the polygonal line 506) corresponding to the graph 600b based on the count results in the OUT direction 503 on the processing target image 500. Next, in S806, the display control unit 203 displays the output image generated by the generation unit 209 in S805 on the display 130.

Next, in S807, the generation unit 209 determines whether the images of the target period have been processed. Specifically, among the images captured during the target period, if there is an image after the imaging date and time of the current processing target image, the generation unit 209 determines that the images of the target period have not been processed (NO in S807), and the processing returns to S801. The generation unit 209 determines a new processing target image from the images that are captured in the target period and that are after the imaging date and time of the processing target image. For example, the generation unit 209 determines the image of the next frame after the processing target image to be a new processing target image. However, if there is not an image after the imaging date and time of the current processing target image from among the images captured in the target period, the generation unit 209 determines that the images of the target period have been processed (YES in S807) and ends the processing of the flowchart illustrated in FIG. 8. In the example illustrated in FIG. 8, while the counting period is the period from the start time of the user-specified target period to the imaging date and time of the current processing target image, the present exemplary embodiment is not limited to this example. For example, if the user specifies the number of objects, a period close to the current time, the period being from the time when the user-specified number of objects in total have passed a passage line to the current time, may be set as the counting period. In the above description, while the generation unit 209 generates an output image by superimposing a figure corresponding to the graph 600a based on the count results in the IN direction 502 and a figure corresponding to the graph 600b based on the count results in the OUT direction 503 on the image 500, the present exemplary embodiment is not limited to this example. The generation unit 209 may generate an output image by superimposing either the figure corresponding to the graph 600a or the figure corresponding to the graph 600b on the image 500.

As described above, the information processing apparatus 100 according to the present exemplary embodiment acquires, for each of a plurality of different locations on a single passage line, a count result of the objects that have passed through the single passage line in a first direction and a count result of the objects that have passed through the single passage line in a second direction different from the first direction. Next, the information processing apparatus 100 generates an output image by superimposing a first figure corresponding to a first graph based on the count results in the first direction and a second figure corresponding to a second graph based on the count results in the second direction on a captured image and displays the resultant image on the display 130. As described above, by setting a plurality of different locations on a single passage line and presenting, to a user, an output image on which the figures based on the count results corresponding to the respective locations are superimposed, the bias in the number of objects that have passed through the passage line can be presented to the user. In this case, since the user only needs to specify a single passage line, not a plurality of passage lines, a detailed passage status of the objects that have passed through the passage line can be presented to the user with a simple operation.

An information processing apparatus 100 according to a second exemplary embodiment generates an output image by superimposing a figure corresponding to a graph based on the number of objects that have passed through a passage line during a first counting period and a figure corresponding to a graph based on the number of objects that have passed through the passage line during a second counting period on a captured image. The following description will be made with a focus on the different from the first exemplary embodiment. Thus, the same or equivalent components and processing of the second exemplary embodiment as those according to the first exemplary embodiment will be denoted by the same reference characters, and redundant description thereof will be avoided.

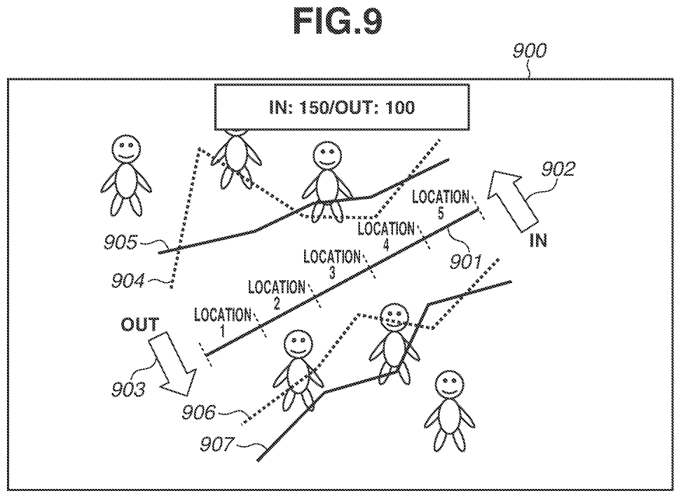

FIG. 9 illustrates an output image generated by a generation unit 209 according to the present exemplary embodiment. The generation unit 209 superimposes a first figure 904 corresponding to a first graph based on the count results of the objects that have passed through a passage line 901 in an IN direction 902 during a first counting period on an image 900. In addition, the generation unit 209 superimposes a second figure 906 corresponding to a second graph based on the count results of the objects that have passed through the passage line 901 in an OUT direction 903 during the first counting period on the image 900. In addition, the generation unit 209 superimposes a third figure 905 corresponding to a third graph based on the count results of the objects that have passed through the passage line 901 in the IN direction 902 during a second counting period different from the first counting period on the image 900. In addition, the generation unit 209 superimposes a fourth figure 907 corresponding to a fourth graph based on the count results of the objects that have passed through the passage line 901 in the OUT direction 903 during the second counting period on the image 900. As illustrated in FIG. 9, the figure 904 and figure 906 corresponding to the first counting period are displayed in a first display mode, and the figure 905 and figure 907 corresponding to the second counting period are displayed in a second display mode different from the first display mode. Specifically, the figure 904 and figure 906 corresponding to the first counting period are displayed as solid polygonal lines, and the figure 905 and figure 907 corresponding to the second counting period are displayed as dotted polygonal lines.

The first counting period and the second counting period are each determined by a user operation. For example, the operation reception unit 202 receives a user operation specifying “2020/07/02 13:00 to 14:00,” as the first counting period and “2020/07/01 13:00 to 14:00” as the second counting period. In this case, the generation unit 209 generates graphs corresponding to the first counting period and the second counting period specified by the user operation and generates an output image by superimposing figures based on the generated graphs on a captured image.

To generate an output image as described above, the information processing apparatus 100 according to the present exemplary embodiment superimposes the first figure 904 based on the count results of the objects that have passed through the passage line 901 in a first direction during the first counting period and the third figure 905 based on the count results of the objects that have passed through the passage line 901 in the first direction during the second counting period on a captured image. In addition, to generate the output image, the information processing apparatus 100 superimposes the second figure 906 based on the count results of the objects that have passed through the passage line 901 in a second direction during the first counting period and the fourth figure 907 based on the count results of the objects that have passed through the passage line 901 in the second direction during the second counting period on the captured image. By presenting, to the user, the image on which the figures based on the count results during the plurality of different counting periods are superimposed, the user can compare the passage statuses of the objects during the different counting periods. In this case, since the user only needs to specify a single passage line, not a plurality of passage lines, a detailed passage status of the objects that have passed through the passage line can be presented to the user with a simple operation.

The information processing apparatus 100 according to each of the above exemplary embodiments acquires, for each of a plurality of different locations on a single passage line, a count result of the objects that passed through the single passage line and generates an output image by superimposing figures corresponding to graphs based on the acquired count results on an image. The information processing apparatus 100 according to the third exemplary embodiment acquires, for each of the plurality of different locations on a single passage line, an average speed of the objects that passed through the single passage line and generates an output image by superimposing figures corresponding to graphs based on the acquired average speeds on an image.

When an object passes through a single passage line set on an image, a determination unit 207 according to the present exemplary embodiment determines the speed of the object. The speed of the object is calculated as follows, for example. That is, a tracking unit 205 associates coordinates of a single object at time T and those at time T+Δt. A value obtained by dividing the distance between the coordinates of the object at time T and the coordinates of the object at time T+Δt by Δt is the speed of the object. A storage unit 201 records (stores) the speed of the object that has passed through the passage line in the passage information 400 illustrated in FIG. 4.

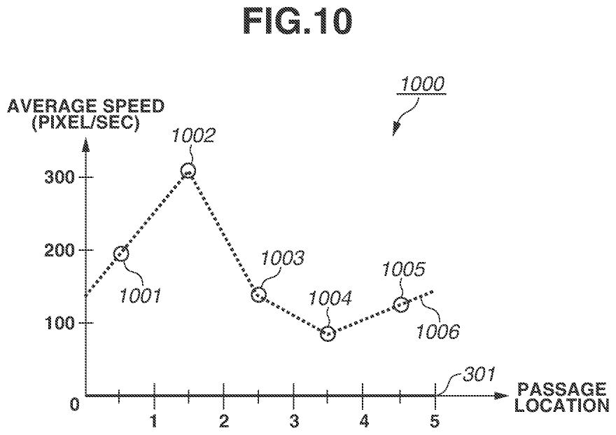

In addition, a calculation unit 208 according to the present exemplary embodiment calculates, for each of the plurality of different locations on a passage line, an average speed value of the objects that have passed through the passage line in a first direction during an counting period. In addition, a generation unit 209 generates a graph corresponding to the average speed value of the objects, based on the average speed value of the objects calculated for each of the plurality of locations on the passage line by the calculation unit 208. A graph 1000 illustrated in FIG. 10 indicates a graph based on the average speed value of the objects that have passed through the passage line in the IN direction generated by the generation unit 209 according to the present exemplary embodiment. The following example assumes a case where the average speed value of the objects that have passed through the “location 1” on the passage line 301 set on the image 300 illustrated FIG. 3 during an counting period in IN the direction 302 is 200 (pixel/sec). In this case, the generation unit 209 determines a section (0 to 1) on the horizontal axis of the graph 1000 corresponding to “location 1” on the passage line 301, and plots an element 1001 at the location corresponding to numeral value 200 on the vertical axis (count result) and the midpoint (0.5) of the determined section on the horizontal axis. That is, the element 1001 plotted by the generation unit 209 indicates an average speed value of the objects that have passed the section of “location 1” illustrated in FIG. 3 in the IN direction 502 during a counting period. Likewise, the generation unit 209 plots element 1002 to element 1005 on the graph 1000 for “location 2” to “location 5”, respectively. That is, the element 1002 plotted by the generation unit 209 on the graph 1000 indicates an average speed value of the objects that have passed through the section of “location 2” in the IN direction 502 during the counting period. In addition, the element 1003 plotted by the generation unit 209 on the graph 1000 indicates an average speed value of the objects that have passed through the section of “location 3” in the IN direction 502 during the counting period. In addition, the element 1004 plotted by the generation unit 209 on the graph 1000 indicates an average speed value of the objects that have passed through the section of “location 4” in the IN direction 502 during the counting period. In addition, the element 1005 plotted by the generation unit 209 on the graph 1000 indicates an average speed value of the objects that have passed through the section of “location 5” in the IN direction 502 during the counting period.

The generation unit 209 generates the graph 1000 by rendering a polygonal line 1006 connecting the elements 1001 to 1005 plotted on the graph 1000 for the five locations “location 1” to “location 5”. Next, the generation unit 209 generates an output image by superimposing the polygonal line 1006 included in the graph 1000 as a figure corresponding to the graph 1000 based on the count results of the objects that have passed through the passage line in the IN direction 502 for the plurality of different locations on the passage line on a captured image. According to the present exemplary embodiment, the polygonal line corresponding to the average speed value of the objects that have passed through the passage line in the IN direction is superimposed on the image at the following location. That is, first, the image is divided into two areas by extension of the passage line. Next, between the two areas of the image obtained by the division, the polygonal line is superimposed on the area where the objects that have passed through the passage line in the IN direction 502 are present. While the above description has been made assuming that the generation unit 209 generates an output image by superimposing a figure corresponding to a graph based on the speed of the objects that have passed through each location on a passage line in first direction (IN direction) on a captured image, the like processing is also performed in the second direction (OUT direction). Thus, the generation unit 209 generates an output image by superimposing a first figure corresponding to a first graph based on the speed of the objects that have passed through the passage line in first direction (IN direction) and a second figure corresponding to second graph based on the speed of the objects that have passed through the passage line in the second direction (OUT direction) on a captured image. The generation unit 209 may generate an output image as follows. That is, the generation unit 209 may generate an output image by superimposing either the first figure corresponding to the first graph based on the speed of the objects that have passed through the passage line in the first direction or the second figure corresponding to the second graph based on the speed of the objects that have passed through the passage line in the second direction on the captured image.

As described above, the information processing apparatus 100 according to the present exemplary embodiment acquires, for each of a plurality of different locations on a single passage line, an average speed value of the objects that have passed through the single passage line in a first direction and an average speed value of the objects that have passed through the single passage line in a second direction different from the first direction. Next, the information processing apparatus 100 generates an output image by superimposing the first figure corresponding to the first graph based on the average speed value in the first direction and the second figure corresponding to the second graph based on the average speed value in the second direction on a captured image and displays the captured image on the display 130. As described above, by setting a plurality of different locations on a single passage line and presenting an output image on which figures based on average speed values corresponding to the plurality of locations are superimposed, a detailed passage status of the objects that have passed through the passage line can be presented to the user. In this case, since the user only needs to specify a single passage line, not a plurality of passage lines, it is possible to present a detailed passage status of the objects that have passed through the passage line to the user with a simple operation.

Next, a hardware configuration of the information processing apparatus 100 for realizing each of the functions of the above exemplary embodiments will be described with reference to FIG. 11. While a hardware configuration of the information processing apparatus 100 will hereinafter be described, the recording apparatus 120 and the imaging apparatus 110 may also be realized by a similar hardware configuration.

The information processing apparatus 100 according to the exemplary embodiment includes the CPU 1100, the RAM 1110, the ROM 1120, the HDD 1130, and an interface (I/F) 1140.

The CPU 1100 comprehensively controls the information processing apparatus 100. The RAM 1110 temporarily stores a computer program executed by the CPU 1100. In addition, the RAM 1110 provides a work area used by the CPU 1100 to execute its processing. For example, the RAM 1110 also functions as a frame memory or a buffer memory.

The ROM 1120 stores a program, etc. used by the CPU 1100 to control the information processing apparatus 100. The HDD 1130 is a storage device storing image data, etc.

The I/F 1140 communicates with an external apparatus in accordance with Transmission Control Protocol/Internet Protocol (TCP/IP), Hyper Text Transfer Protocol (HTTP), or the like via the network 140.

While the above exemplary embodiments have been described based on an example in which the CPU 1100 performs processing, at least part of the processing of the CPU 1100 may be performed by a dedicated hardware component. For example, the processing for displaying a graphical user interface (GUI) or image data on the display 130 may be performed by a graphics processing unit (GPU). The processing for reading a program code from the ROM 1120 and expanding the program code on the RAM 1110 may be performed by a direct memory access (DMA) that functions as a transfer device.

At least one processor may read and execute a program that realizes at least one of the functions according to the above exemplary embodiments. The program may be supplied to a system or an apparatus having a processor via a network or a storage medium. Some embodiments may be realized by a circuit (for example, an application specific integrated circuit (ASIC)) that realizes at least one of the functions according to the above exemplary embodiments. The units of the information processing apparatus 100 may be realized by the hardware components illustrated in FIG. 11 or software components.

Another apparatus may include at least one of the functions of the information processing apparatus 100 according to the above exemplary embodiments. For example, the imaging apparatus 110 may include at least one of the functions of the information processing apparatus 100 according to the above exemplary embodiments. Some embodiments may be carried out by combining the above exemplary embodiments, for example, by arbitrarily combining the above exemplary embodiments.

While the present disclosure has described exemplary embodiments, these exemplary embodiments are only examples. These exemplary embodiments shall not be deemed to limit the technical scope of every embodiment. That is, some embodiments can be carried out in various forms without departing from technical concept or main features thereof. For example, various combinations of the exemplary embodiments are included in the content of the disclosure of the present description.

### Other Embodiments

Some embodiment(s) can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2020-130510, filed Jul. 31, 2020, which is hereby incorporated by reference herein in its entirety.

What is claimed is:

1. An information processing apparatus comprising:
an acquisition unit configured to acquire, for each of a plurality of different locations on a passage line set based on a user operation on an image captured by an imaging unit, a number of objects that have passed through the passage line; and
a display control unit configured to display, for each of the plurality of different locations on the passage line, information based on the number of objects that have passed through the passage line on a display unit.

2. The information processing apparatus according to claim 1, wherein the display control unit displays, on the display unit, the image on which the information is superimposed.

3. The information processing apparatus according to claim 1, wherein the display control unit displays, on the display unit, for each of the plurality of different locations on the passage line, the image on which a figure corresponding to a graph indicating the number of objects that have passed through the passage line is superimposed.

4. The information processing apparatus according to claim 1, wherein the display control unit displays, on the display unit, for each of the plurality of different locations on the passage line, the image on which at least one of a first figure corresponding to a first graph indicating a number of objects that have passed through the passage line in a first direction and a second figure corresponding to a second graph indicating a number of objects that have passed through the passage line in a second direction different from the first direction is superimposed.

5. The information processing apparatus according to claim 4, wherein the display control unit displays, on the display unit, for each of the plurality of different locations on the passage line, the image on which at least one of the first figure corresponding to the first graph indicating a number of objects that have passed through the passage line in the first direction during a first counting period and the second figure corresponding to the second graph indicating a number of objects that have passed through the passage line in the second direction during the first counting period.

6. The information processing apparatus according to claim 5, wherein the display control unit displays, on the display unit, for each of the plurality of different locations on the passage line, the image on which at least one of the first figure corresponding to the first graph indicating the number of objects that have passed through the passage line in the first direction during the first counting period and a third figure corresponding to a third graph indicating a number of objects that have passed through the passage line in the first direction during a second counting period different from the first counting period.

7. The information processing apparatus according to claim 6, wherein the first figure and the third figure are displayed in different display modes.

8. The information processing apparatus according to claim 1, wherein the plurality of locations on the passage line correspond to a plurality of sections obtained by dividing the passage line into a plurality of segments.

9. The information processing apparatus according to claim 8, wherein the number of sections on the passage line is settable based on a user operation.

10. The information processing apparatus according to claim 1, wherein the objects are people.

11. An information processing method comprising:
acquiring, for each of a plurality of different locations on a passage line set based on a user operation on an image captured by an imaging unit, a number of objects that have passed through the passage line; and
displaying, on a display unit, for each of the plurality of different locations on the passage line, information based on the number of objects that have passed through the passage line.

12. The information processing method according to claim 11, wherein, the displaying includes displaying, on the display unit, for each of the plurality of different locations on the passage line, the image on which a figure corresponding to a graph indicating the number of objects that have passed through the passage line is superimposed.

13. The information processing method according to claim 11, wherein the displaying includes displaying, on the display unit, for each of the plurality of different locations on the passage line, the image on which at least one of a first figure corresponding to a first graph indicating a number of objects that have passed through the passage line in a first direction and a second figure corresponding to a second graph indicating a number of objects that have passed through the passage line in a second direction different from the first direction is superimposed.

14. The information processing method according to claim 11, wherein the displaying includes displaying, on the display unit, for each of the plurality of different locations on the passage line, the image on which at least one of the first figure corresponding to the first graph indicating a number of objects that have passed through the passage line in the first direction during a first counting period and the second figure corresponding to the second graph indicating a number of objects that have passed through the passage line in the second direction during the first counting period.

15. The information processing method according to claim 14, wherein the displaying includes displaying, on the display unit, for each of the plurality of different locations on the passage line, the image on which at least one of the first figure corresponding to the first graph indicating the number of objects that have passed through the passage line in the first direction during the first counting period and a third figure corresponding to a third graph indicating a number of objects that have passed through the passage line in the first direction during a second counting period different from the first counting period.

16. The information processing method according to claim 15, wherein the first figure and the third figure are displayed in different display modes.

17. The information processing method according to claim 11, wherein the plurality of locations on the passage line correspond to a plurality of sections obtained by dividing the passage line into a plurality of segments.

18. The information processing method according to claim 17, wherein the number of sections on the passage line is settable based on a user operation.

19. The information processing method according to claim 11, wherein the objects are people.

20. A computer-readable non-transitory recording medium storing a program for causing a computer to perform a procedure including:
acquiring, for each of a plurality of different locations on a passage line set based on a user operation on an image captured by an imaging unit, a number of objects that have passed through the passage line; and
displaying, on a display unit, for each of the plurality of different locations on the passage line, information based on the number of objects that have passed through the passage line.
